(19) United States
(12) Patent Application Publication
(10) Pub. No.: US 2021/0118008 A1
(43) Pub. Date: Apr. 22, 2021

(54) SEARCH QUERY ADVERTISEMENTS

(71) Applicant: Branch Metrics, Inc., Redwood City, CA (US)

(72) Inventors: Eric J. Glover, Palo Alto, CA (US); Colin Nathan Behr, San Francisco, CA (US); Antonio Garcia-Martinez, Redwood City, CA (US)

(73) Assignee: Branch Metrics, Inc., Redwood City, CA (US)

(21) Appl. No.: 17/073,627

(22) Filed: Oct. 19, 2020

Related U.S. Application Data
(60) Provisional application No. 62/923,777, filed on Oct. 21, 2019.

(51) Int. Cl. G06Q 30/02; G06F 16/9032; G06F 16/9537; G06F 16/9538; G06Q 30/06

(52) U.S. Cl. CPC G06Q 30/0256; G06F 16/90324; G06F 16/9537; G06F 16/9538; G06F 3/0482; G06Q 30/0261; G06Q 30/0267; G06Q 30/0247; G06Q 30/0625; G06Q 30/0275

(57) ABSTRACT

A method includes receiving a first request from a user device. The first request includes a partial search query sent from the user device while a user is typing a search query. The method includes generating one or more suggested search queries based on the partial search query and selecting a query advertisement record based on the partial search query. The query advertisement record includes an advertised search query and a bid price associated with the advertised search query. The method further includes sending a first response to the user device that includes the advertised search query and the one or more suggested search queries. The method further includes receiving a second request that includes the advertised search query, generating search results based on the advertised search query included in the second request, and sending the search results to the user device.

### CROSS-REFERENCE TO RELATED APPLICATIONS

This application claims the benefit of U.S. Provisional Application No. 62/923,777, filed on Oct. 21, 2019. The disclosure of the above application is incorporated herein by reference in its entirety.

### FIELD

The present disclosure relates to providing advertisements in a search interface.

### BACKGROUND

Software developers can develop websites and applications that are accessed by users on a variety of different platforms, such as different computing devices and operating systems. Website and application search engines can search the websites and applications for a user. For example, a user can enter a search query into a search engine and receive website and application search results for the search query in a search engine results page (SERP). Advertisers, such as application developers and other business entities, may advertise their applications, services, and other products in SERPs across a variety of different computing platforms. In order to efficiently advertise their applications, services, and other products, advertisers may advertise to a targeted audience.

### SUMMARY

In one example, a method comprises receiving, at a computing device, a first request from a user device. The first request includes a partial search query sent from the user device while a user is typing a search query. The method further comprises generating one or more suggested search queries based on the partial search query and selecting a query advertisement record based on the partial search query. The query advertisement record includes an advertised search query and a bid price associated with the advertised search query. The method further comprises sending a first response to the user device. The first response includes the advertised search query and the one or more suggested search queries. The method further comprises receiving a second request that includes the advertised search query, generating search results based on the advertised search query included in the second request, and sending the search results to the user device.

In one example, a system comprises one or more storage devices configured to store a plurality of query advertisement records. The system comprises one or more processing units that execute computer-readable instructions that cause the one or more processing units to receive a first request from a user device. The first request includes a partial search query sent from the user device while a user is typing a search query. The one or more processing units are configured to generate one or more suggested search queries based on the partial search query and select a query advertisement record based on the partial search query. The selected query advertisement record includes an advertised search query and a bid price associated with the advertised search query. The one or more processing units are configured to send a first response to the user device. The first response includes the advertised search query and the one or more suggested search queries. The one or more processing units are configured to receive a second request that includes the advertised search query, generate search results based on the advertised search query included in the second request, and send the search results to the user device.

In one example, a system comprises means for receiving a first request from a user device. The first request includes a partial search query sent from the user device while a user is typing a search query. The system further comprises means for generating one or more suggested search queries based on the partial search query and selecting a query advertisement record based on the partial search query. The query advertisement record includes an advertised search query and a bid price associated with the advertised search query. The system further comprises means for sending a first response to the user device. The first response includes the advertised search query and the one or more suggested search queries. The system further comprises means for receiving a second request that includes the advertised search query, generating search results based on the advertised search query included in the second request, and sending the search results to the user device.

In one example, a method comprises generating, at a user device, a search interface that includes a search box, generating an advertisement request based on a partial search query entered into the search box, and sending the advertisement request to an advertisement system. The method further comprises receiving an advertisement response from the advertisement system, wherein the advertisement response includes an advertised search query. The method further comprises displaying the advertised search query in the search interface, detecting user selection of the advertised search query, and sending a search request to a search system that includes the advertised search query.

In one example, a user device is configured to generate a search interface that includes a search box, generate an advertisement request based on a partial search query entered into the search box, and send the advertisement request to an advertisement system. The user device is further configured to receive an advertisement response from the advertisement system, wherein the advertisement response includes an advertised search query. The user device is further configured to display the advertised search query in the search interface, detect user selection of the advertised search query, and send a search request to a search system that includes the advertised search query.

In one example, a non-transitory computer-readable medium comprises executable instructions, the executable instructions causing a processing unit of a user device to generate a search interface that includes a search box, generate an advertisement request based on a partial search query entered into the search box, and send the advertisement request to an advertisement system. The processing unit is further configured to receive an advertisement response from the advertisement system, wherein the advertisement response includes an advertised search query. The processing unit is further configured to display the advertised search query in the search interface, detect user selection of the advertised search query, and send a search request to a search system that includes the advertised search query.

In one example, a system comprises means for generating a search interface that includes a search box, generating an advertisement request based on a partial search query entered into the search box, and sending the advertisement request to an advertisement system. The system further comprises means for receiving an advertisement response from the advertisement system, wherein the advertisement response includes an advertised search query. The system further comprises means for displaying the advertised search query in the search interface, detecting user selection of the advertised search query, and sending a search request to a search system that includes the advertised search query.

### BRIEF DESCRIPTION OF THE DRAWINGS

The present disclosure will become more fully understood from the detailed description and the accompanying drawings.

FIG. 1 illustrates an environment that includes an example advertisement system of the present disclosure.

FIG. 2 illustrates example interactions between a user device, a search system, and an advertisement system.

FIG. 3 illustrates an example method that describes operation of an advertisement system, a search system, and a user device that includes a search application.

FIGS. 4A-4B illustrate example search graphical user interfaces including query advertisements.

FIG. 5 illustrates an example method that describes generation of a query advertisement in response to a partially entered search query.

FIG. 6 illustrates an example method that describes generation of a query advertisement in response to display of a search box.

FIG. 7 illustrates an example method that describes generation of a query advertisement in response to a suggested search query.

FIG. 8A is a functional block diagram of a user device that provides local search results and local query advertisements.

FIG. 8B illustrates an example method for generating local query advertisements on a user device.

In the drawings, reference numbers may be reused to identify similar and/or identical elements.

### DETAILED DESCRIPTION

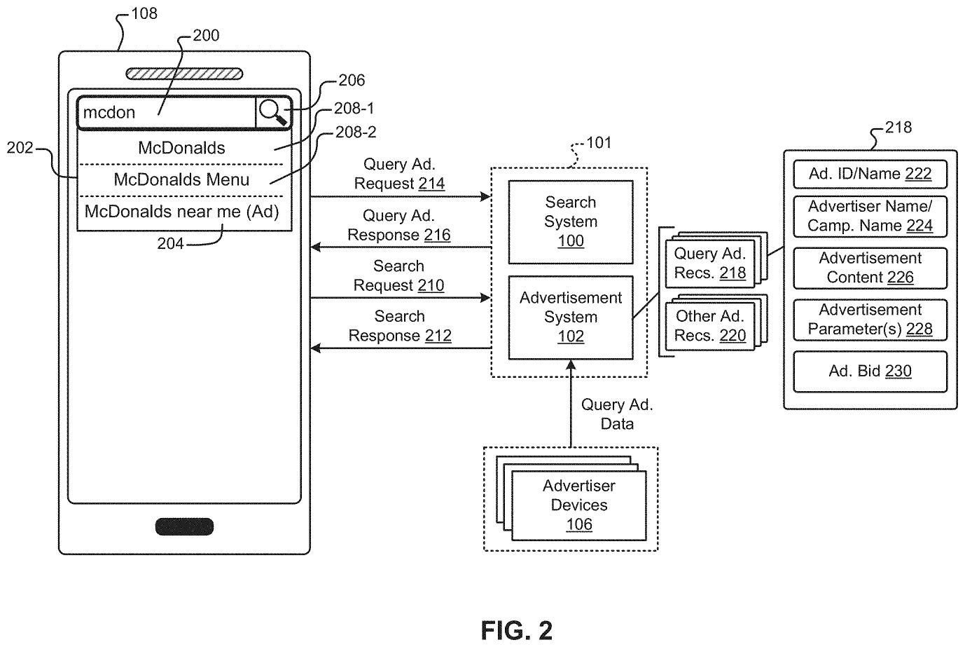

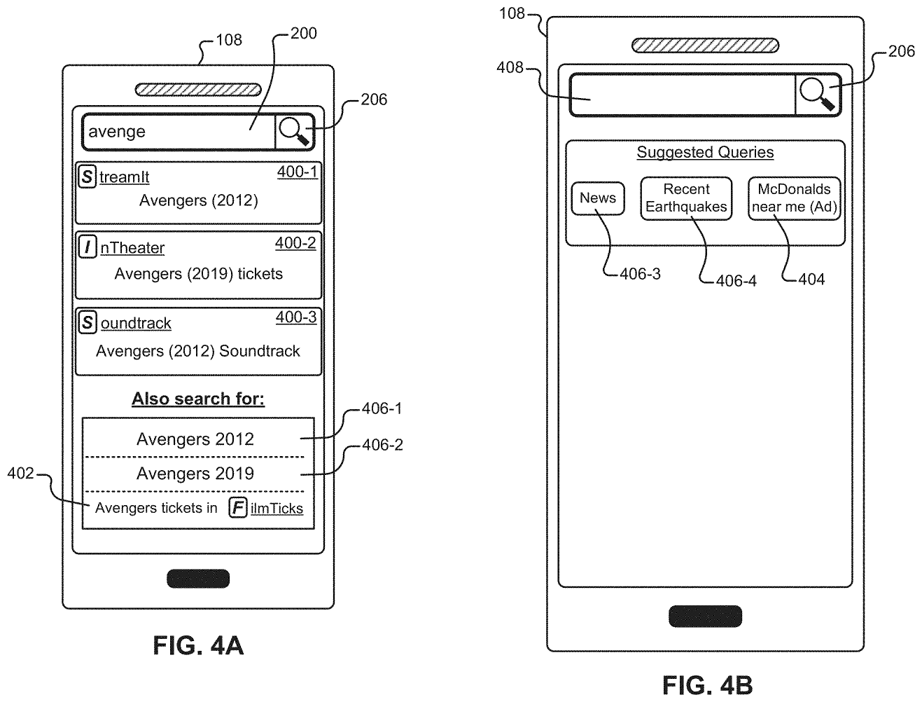

A search system 100 and an advertisement system 102 of the present disclosure may generate search query advertisements (hereinafter “query advertisements”) that may be displayed in a search application, search website, and/or a search component included in an application/website. The query advertisements may refer to search queries that are paid for by a party, such as a business and/or an application developer. For example, a party may pay for query advertisements in order to have their search queries displayed to a user prior to, or during, an application/web search. The query advertisements described herein may provide advertisers with a route to promote their business and/or drive traffic to their application, while also conveniently providing users with relevant search queries. Example query advertisements are illustrated at 204, 402, and 404 in FIG. 2 and FIGS. 4A-4B.

Advertisers may interface with the advertisement system 102 to create query advertisements and define parameters associated with the query advertisements. For example, the advertisers may specify the query terms associated with a query advertisement. The advertisers may also define various targeting parameters for query advertisements that, when satisfied, may result in the display of a query advertisement in a user's search interface. Example targeting parameters may include, but are not limited to, a user's partial/whole search query, a user's context (e.g., geolocation), a user's search history (e.g., prior queries/selections), applications installed on the user device, and a user's historical application/web usage. In some implementations, a query advertisement may be selected and displayed to the user based on potential events that may occur in response to selection of the query advertisement. For example, a query advertisement may be selected based on: 1) advertisements that may be shown to a user or selected by a user, 2) potential search results that may be shown to a user or selected by a user, and/or 3) other potential downstream events (e.g., installation events and/or commerce events) that may occur after selection of the query advertisement. In some implementations, the advertisement system 102 may select query advertisements based on bid prices specified by the advertisers and/or estimated monetary values of the query advertisements.

The query advertisements may be placed in a variety of locations. In some implementations, the query advertisements may be placed in a search interface that a user may use to perform application/web searches. For example, query advertisements may be placed in a dedicated search application interface (e.g., see FIG. 2 and FIGS. 4A-4B), in an application-specific search interface (e.g., included in any installed application), and/or on a search website. In a more specific example, the query advertisements may be placed near a search box 200 (i.e., search bar) in a search application, such as in a drop-down portion 202 of a search box 200 rendered below the search box 200 in which the user is entering a query. In some implementations, the query advertisements may be in the form of query suggestions or autocompletions. The query advertisements may be displayed at a variety of times in a search interface, such as before/during entry of a user's search query. As such, the query advertisements may attract a user's attention as early as possible in the search interface, which may increase the chances of a user engaging with an advertisement.

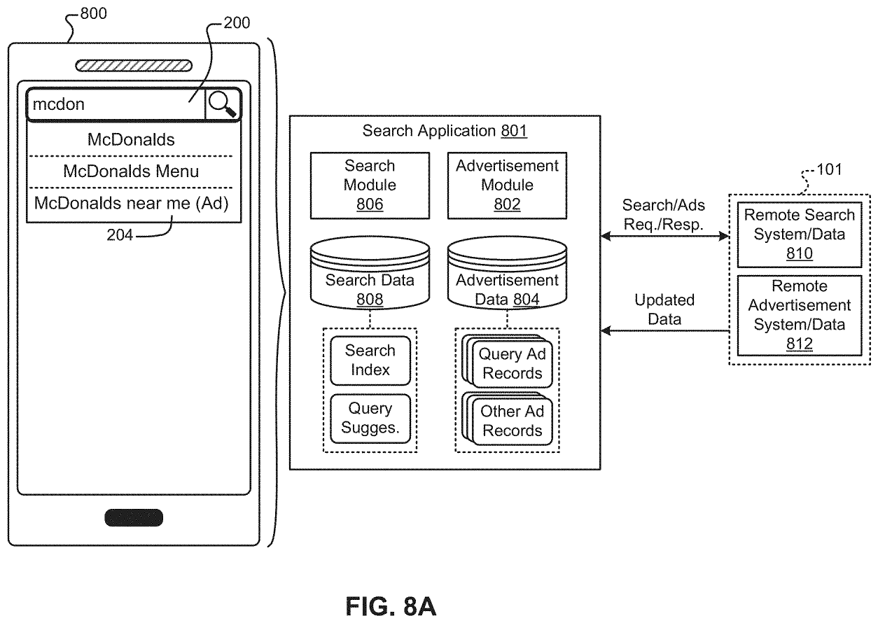

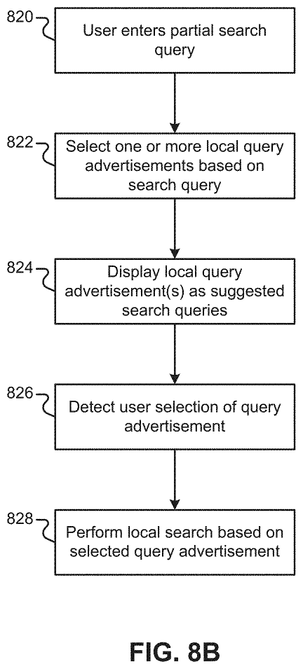

A user can select (e.g., touch/click) a displayed query advertisement. Selecting the query advertisement may result in execution of the search query associated with the query advertisement. For example, selection of a query advertisement may cause execution of the search query as though the search query was entered into the search interface (e.g., the search box), although other selection behavior may be defined. In one example, selection of a query advertisement near a search box may cause the search query to be entered into the search box. Additionally, in some implementations, the search query may be executed. A remote search system 100, or local device search (e.g., see FIG. 8A), may provide search results for the executed query advertisement. The search interface may display the search results in a search engine results page (SERP).

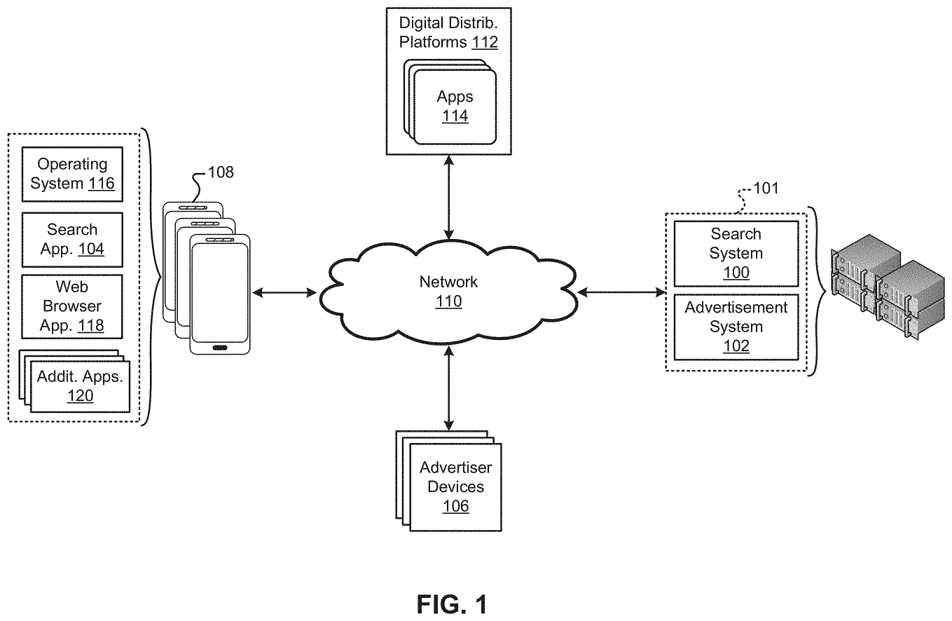

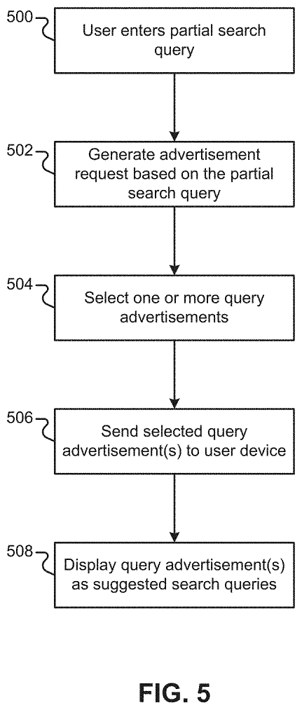

FIGS. 1-3 illustrate and describe operation of an example advertisement system 102 and search application 104 that may generate and display query advertisements. FIGS. 4A-4B illustrate example graphical user interfaces (GUIs) including query advertisements. FIGS. 5-7 illustrate example methods for generating and displaying query advertisements for different triggers and targeting parameters. FIGS. 8A-8B illustrate local search and local query advertisement functionality on a user device.

FIG. 1 illustrates an environment that includes a plurality of advertiser devices 106, user devices 108, a search system 100 (e.g., a server computing device), and an advertisement system 102 (e.g., a server computing device) in communication via a network 110. The network may include various types of computer networks, such as a local area network (LAN), wide area network (WAN), and/or the Internet. The user devices 108 may include, but are not limited to, smart phones, wearable computing devices (e.g., watches), tablet computers, laptop computers, desktop computers, and additional computing device form factors.

Advertiser devices 106 may communicate with the advertisement system 102 via the network 110. Advertiser devices 106 may be computing devices used by advertisers to generate advertisement data, such as query advertisement data and other advertisement data. The advertisement system 102 may generate advertisements for the user devices 108 based on the advertisement data generated by advertisers. The advertiser devices 106 may include, but are not limited to, smart phones, tablet computers, laptop computers, desktop computers, and additional computing device form factors.

Advertisers may include any party that advertises goods, services, businesses, or any other entities. For example, advertisers may include, but are not limited to, companies seeking to advertise goods and/or services, advertising agencies, and application developers. Different advertisers may have different goals, depending on the advertisement subject matter. For example, some application developer advertisers may generate advertisements (e.g., query advertisements) that are meant to promote installation of their applications (e.g., using targeted search queries). As another example, some developer advertisers may generate advertisements (e.g., query advertisements) that are meant to promote traffic to their application (e.g., using targeted search queries). Some advertisers may generate advertisements (e.g., query advertisements) that are meant to drive traffic to specific products and/or services (e.g., using targeted search queries).

The search system 100 may receive search requests including search queries from the user devices 108. The search system 100 processes the search queries, performs one or more searches, and outputs search results that include user-selectable links to application states and/or websites. The application states (e.g., for installed applications) and/or websites may be associated with entities and actions that resolve the user's search query. For example, the user-selectable links may access content (e.g., pages) for business entities, movie entities, music entities, and other types of entities. Although a remote search system 100 may receive search requests from user devices 108 and generate search results, in some implementations, a user device may include local search and/or advertising functionality (e.g., see FIGS. 8A-8B). In some implementations, the search system 100 may handle search requests from other parties (e.g., other servers) that interface with the user devices 108.

The environment includes one or more digital distribution platforms 112. The digital distribution platforms 112 may represent computing systems that are configured to distribute applications 114 to user devices. Example digital distribution platforms include, but are not limited to, the GOOGLE PLAY® digital distribution platform by Google, Inc. and the APP STORE® digital distribution platform by Apple, Inc. Users may download the applications 114 from the digital distribution platforms 112 and install the applications 114 on user devices 108.

A user device 108 includes an operating system 116 and a plurality of applications, such as a search application 104, a web browser application 118, and additional applications 120. Example additional applications may include, but are not limited to, e-commerce applications, social media applications, business review applications, banking applications, gaming applications, and weather forecast applications. Using the web browser 118, the user device 108 can access various websites via the network 110. The user device 108 may also download applications from the digital distribution platforms 112 via the network 110 and install the applications.

The search application 104 can communicate with the search system 100 to receive search results. For example, the search application 104 can receive a user's search query and make a search request to the search system 100. The search application 104 can receive and display search results received from the search system 100. In some implementations, the installed search application 104 may perform local searches on the user device 108 and/or provide query advertisements based on local data stored on the user device 108.

Search results received by the search application 104 can include display data for rendering the search results in a search GUI. The display data may include, but is not limited to: 1) the application/website name, 2) the title of the result (e.g., a restaurant name), 3) a description of the state/website associated with the result (e.g., a description of a restaurant), 4) one or more images associated with the application state/website, and 5) one or more actions associated with the result. The search results can also include link data, such as uniform resource identifiers (URIs), uniform resource locators (URLs), and/or metadata. The link data (e.g., URIs, URLs, and/or metadata) may be used by the user device 108 (e.g., applications and/or web browser) to access application states and/or websites associated with the search results. An application state may generally refer to a page/screen of an application. In some cases, the search results can include application/website URIs/URLs that launch the application states/websites on the user device. In other cases, the search results can include application metadata (e.g., application-specific IDs or other data) that applications can use to access the application states. In some implementations, the search results and/or the query advertisements may include tracking information, such as directions to send click data for analytics (e.g., to an analytics server).

FIG. 4A illustrates an example GUI that includes a plurality of search results 400-1, 400-2, 400-3. The search results include: 1) a link 400-1 for streaming the Avengers 2012 movie in the Stream It application, 2) a link 400-2 for Avengers 2019 tickets in the InTheater application, and 3) a link 400-3 for the avengers 2012 soundtrack in the Soundtrack application. In some implementations, the search results may include advertisements in addition to the query advertisements described herein. The user can select one of the search results 400 in the GUI. The user device 108 can open the application state associated with the search result using the data included in the received search result. The user may then interact with the accessed application state. In another specific example (not illustrated), with respect to the YELP® business directory application developed by Yelp, Inc., selecting a YELP® application search result for a Round Table Pizza restaurant may access a Round Table Pizza application state of the YELP® application.

The search application 104 may be implemented on the user device 108 in a variety of ways. In some implementations, the user may download the search application 104 (e.g., from a digital distribution platform 112) and install the search application 104 on the user device 108. In other implementations, the search application 104 may be installed on the user device 108 before the user purchases the user device (e.g., as a preloaded application). In some cases, the search application may be referred to as a “native application” or a “widget.” In some implementations, the functionality attributed to the search application herein may be included in other applications, such as a launcher application or as part of a smart assistant device, such as a smart speaker device (e.g., an ECHO smart speaker by Amazon.com, Inc., a GOOGLE HOME smart speaker by Google, Inc., or an Apple HOMEPOD smart speaker by Apple, Inc.). In some implementations, the search application 104 can communicate with the search system 100 via intermediate systems (e.g., other servers). In some implementations, the functionality attributed to the search application 104 herein may be implemented as a web-based search that is accessed using the web browser 118 on the user device 108. In these implementations, the search system 100 may provide web-based search functionality, such as a web-based GUI. In some implementations, the search functionality may be implemented as a component of a larger application, such as a search component of a business review application.

In some implementations, the search system 100 and advertisement system 102 may be owned/operated by the same party (e.g., business). For example, functionality provided by the advertisement system 102 and the search system 100 described herein may be provided by a computing system 101 operated by a single party. The same party (e.g., business) may also develop/operate the search website and/or search application 104. Alternatively, different parties may own/operate the search system 100, the advertisement system 102, and the search application 104.

FIG. 2 illustrates an example search interface. The search interface may be implemented in a variety of ways. For example, a user may interact with a search interface that is a web-based search interface accessed by the web browser application 118. As another example, a user may interact with a search interface provided by a search application on the user device. In some implementations, the search application may be a stand-alone application/widget that the user can manually select to launch. In some implementations, the search functionality may be included as a search component of an application (e.g., a search feature for a business review application). In some implementations, the search application may be accessed by a user gesture, such as swiping the screen to expose a search box 200. Although the search interface may be provided by the web browser application 118 and/or a search application 104, the search interface is described as being associated with a search application 104 hereinafter. The search application interface may provide search results (e.g., user-selectable links) for one or more websites and/or one or more applications.

The user can enter a search query into the search application 104. The search application 104 generates a search request including the search query and other data, such as context data. Context data may include a variety of types of data, such as a user ID, operating system information, device type information, geolocation data, time of day, user state of motion data (e.g., walking, biking, driving), and/or category of the query (e.g., selected in the GUI).

The search application can include a GUI element that receives a user's search query. The GUI element may be referred to herein as a search query box 200 or a search box 200. The text that a user is entering by typing/voice into the search box may be referred to as a “user's search query” or “search query.” The search query may be a partial query (e.g., not fully entered) or a completed search query. The search application 104 may generate additional/alternative search queries that may be displayed to the user before any text is input into the search box, while text is being entered into the search box, or after the search query is completed. The additional queries may be recommended queries, autosuggested queries, or other types of queries (e.g., see 208-1, 208-2, and 406-1 to 406-4). The user may select one of the additional queries to cause a search to be executed using the selected query.

The search application may insert one or more query advertisements into the search interface (e.g., inside or near the search box). One or more query advertisements may be inserted into the search interface alongside additional queries or without additional queries. The user may select one of the query advertisements to cause a search to be executed according to the selected query advertisement.

The search application can include a GUI element that executes a search (e.g., at 206 in FIG. 2). For example, a user may execute a search by selecting (e.g., touching/clicking) the search execution GUI element 206. Executing a search may include transmitting a search request to the search system 100. The search request may include a search query (partial or complete) and additional information, such as context data. The search application 104 may receive and display search results from the search system 100 in response to executing the search.

In some implementations, the search application 104 may automatically execute searches (e.g., without user input) while the user is entering the search query. In these implementations, the search application may display search results while the user is typing the search query. For example, with respect to FIG. 4A, the user is typing a query for “avengers” that yields search results for the partial query “avenge” during typing. In some implementations, the search application 104 may automatically execute searches without user input into the search box 200. In these implementations, the searches may be executed based on other triggers, such as predetermined times, user context, a user accessing the search application (e.g., opening the application), and/or a user gesture (e.g., a swipe).

FIG. 2 illustrates example interactions between the advertiser devices 106, the advertisement system 102, the search system 100, and a user device 108. In response to receiving a search request 210, the search system 100 may generate a search response 212 that includes suggested search queries and/or search results. For example, in some cases (e.g., for an unfinished query), the search system 100 may generate a search response that includes search query suggestions without search results. As another example, the search response may include search query suggestions and search results. In this example, the search query suggestions may be rendered by the search application over top of the underlying rendered search results, such as in a drop down search box 202 over top of rendered results.

The search request 210 may be generated and sent in a variety of scenarios. In some implementations, the search application may generate the search request prior to entry of a search query by the user. For example, the search application may generate a search request in response to user context. In some implementations, the search application may generate the search request while the user is entering (e.g., typing) a search query. For example, the search application may generate a search request that includes a partial (e.g., unfinished) user search query. In some implementations, the search application may generate the search request in response to user input, such as selection of a search button GUI element.

The search application 104 may generate a query advertisement request 214 (hereinafter “advertisement request 214”) that is sent to the search system 100 or the advertisement system 102. An advertisement request 214 may be a request for one or more query advertisements that may be inserted into the search interface. In response to the query advertisement request 214, the advertisement system 102 may generate a query advertisement response 216 that may include one or more query advertisements. In some implementations, the advertisement system 102 may send the query advertisement to the user device. In other implementations, the advertisement system 102 may send the advertisement response 216 to the search system 100, which may then send the advertisement response 216 to the user device 108.

In some implementations, the search and advertisement responses 212, 216 may be sent at different times by the different systems 100, 102. In other implementations, the responses 212, 216 may be sent at approximately the same time by the different systems 100, 102. In implementations where the search system 100 delivers the advertisement response 216, the search system 100 may send the advertisement response 216 at the same time as the search response 212.

Although the search response 212 and the advertisement response 216 are illustrated and described herein as separate responses (e.g., separate data structures) (e.g., see FIG. 2), in some implementations, the search system 100 may combine the search response 212 and advertisement response 216 into the same response. Although different request and response data structures may be implemented, the search and advertisement requests and responses are described hereinafter as separate. Although the search system 100 or the advertisement system 102 may send the advertisement responses to the user device, the search system 100 may be described hereinafter as receiving the advertisement request, acquiring the advertisement response from the advertisement system, and sending the advertisement response to the user device. Also note that multiple request/response cycles may occur while the user is typing the search query. The requests/responses may include different partial search queries, different suggested search queries, different search results, and different query advertisements as the user is typing.

The query advertisements may be rendered in a variety of ways. In some implementations, the query advertisements may be rendered near the search bar (e.g., in a drop down box 202) before or while the user is typing the search query. The query advertisements may also be rendered near the search bar (e.g., in a drop down box 202) after the user types the search query, but before the user selects a search GUI element that executes the search query. Instead of inserting the query advertisements in a drop down box that overlays the search page, in some implementations, the search application may render the query advertisements on the search page, which may or may not include search results (e.g., see FIGS. 4A-4B).

In some implementations, the search system 100 may provide query suggestions 208-1, 208-2 (e.g., organic suggestions without ads) in the search response. In these implementations, the search application 104 may include the query advertisement(s) 204 adjacent to the query suggestions 208-1, 208-2 (e.g., see FIG. 2). In some implementations, the search responses may include search results that are rendered while/after the user is typing. In these implementations, the search application may render the query advertisements in the search results (e.g., see FIG. 4A).

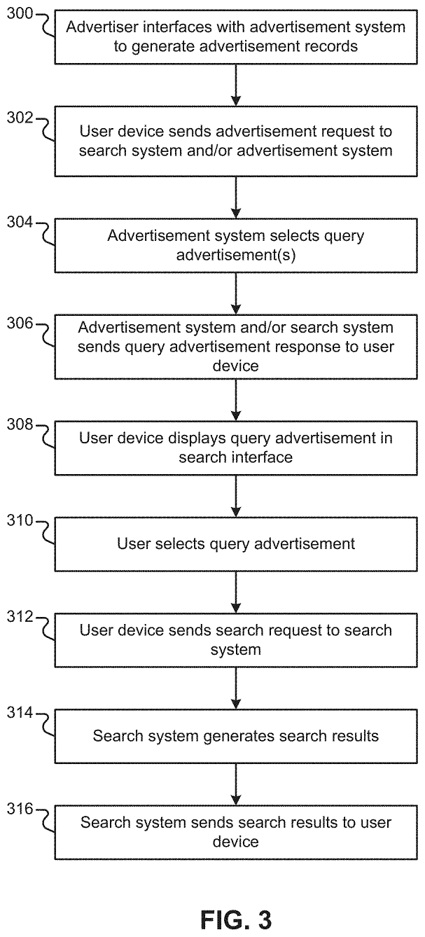

FIG. 3 illustrates an example method that describes operation of the advertisement system 102, the search system 100, and the search application 104 of FIGS. 1-2. In block 300, the advertiser uses an advertiser device 106 to interact with the advertisement system 102. For example, the advertiser device 106 may access an advertiser interface (e.g., a web/application-based interface) provided by the advertisement system 102.

The advertiser may interface with the advertisement system 102 to generate query advertisement records 218 (hereinafter “query ad records 218”) that are stored by the advertisement system 102. A query ad record 218 may include a variety of data that defines when a query advertisement should be shown and how a query advertisement behaves when selected. A plurality of advertisers may each generate a plurality of query ad records 218 that are stored in an advertisement data store (not illustrated) included in the advertisement system 102. The advertisement system 102 may also store and provide other advertisements (i.e., other than query advertisements) to user devices, such as search result ads that are included in search results. The query ad records 218, and other advertisement records 220, may each include an advertisement identifier/name 222 that uniquely identifies the advertisement records in the advertisement system. The advertisement records may also include other information that identifies the advertiser, such as an advertiser name and an advertising campaign name 224.

A query ad record 218 may include advertisement content data 226 that defines the contents of the query advertisement that may be sent to a user device. For example, the advertisement content 226 may define how the query advertisement is rendered and how the query advertisement behaves in response to selection. In some implementations, advertisement content 226 may include one or more query advertisement terms (e.g., query advertisement text) to be included in the query advertisement. The query advertisement terms may include words, numbers, and/or symbols that form a search query that may be selected by the user. In response to selection by a user, the query advertisement terms may be used by the search application/system 104, 100 to perform a search. In some cases, the query advertisement terms may be referred to as an “advertised search query.”

In some implementations, the advertisement content 226 may include query ad display data that indicates how the query advertisement should be displayed. In some examples, the query advertisement terms may be rendered as text in the search application, in a manner similar to other search queries entered by the user or organically suggested. In some examples, the advertisement content 226 may include additional formatting data, such as font type, font size, font color, and other formatting data (e.g., bold, underlined, italicized, etc.). In some examples, the advertisement content 226 may include images that may be displayed in the query advertisement. Example images may include, but are not limited to, icon images (e.g., application icon images), logos (e.g., business/product logos), and/other images. In some implementations, the advertisement content 226 may also specify a layout of the text and/or images, such as the arrangement of the text/images relative to one another (e.g., display text to the left of the image). In some implementations, the advertisement content 226 may specify where the text/images should be located, such as a location in a query box and/or whether the query advertisement is to be labeled as a suggested query, an autocompleted query, etc. Query advertisements may also be accompanied by advertisement indicator text/images (e.g., “Ad” in FIG. 2) that indicates to the user that the query advertisement is an advertisement.

In some implementations, the query advertisement terms (e.g., text) may include search operators that define specific behaviors for selection of the query advertisement. For example, the query advertisement terms may include search operators that may act as commands for the search system/application 100, 104. In one example, search operators may include application/domain specific search operators that indicate the search system 100 should perform a search that is limited to a specific application corpus and/or web domain. In a specific example, the query advertisement text “restaurants site:yelp.com” may search restaurants on the yelp.com domain. In another example, search operators may include exact match operators, such as quotes around the search term, which may require an exact match in the query terms. Additional examples of search operators may include, but are not limited to, category filters, logical operators (e.g., OR, AND, etc.), and search system functionality operators (e.g., dictionary functions, price search functions, map functions, stock information, etc.).

In some implementations, the query advertisement terms (e.g., text) may be supplemented by additional query advertisement metadata that provides additional features to the query advertisement. In some implementations, the query advertisement metadata may be used by the search application 104 and/or the search system 100, but may not be displayed to the user in some cases. The query advertisement metadata may provide similar functionality as the search operators in some cases. In some implementations, the query advertisement metadata may include commands that open applications installed on the user device. In some implementations, the query advertisement metadata may include data used by the applications, such as application-specific search commands that the application may execute. For example, query advertisement metadata may cause an application to launch and perform a search using the query advertisement terms (e.g., text). Example query advertisement metadata may include a URI/URL in some implementations. In a specific example, a query advertisement may include the text “McDonalds near me on Yelp.” In this specific example, the query advertisement metadata may specify that the query advertisement should launch the YELP® application with the query “McDonalds” using a user location equal to the current location. In some cases, the SERP may include a web-view, or a window in the SERP, that is generated by the application.

A query ad record 218 may include advertisement targeting parameters 228 (hereinafter “targeting parameters 228”). The advertiser may specify a plurality of targeting parameters for an advertisement. The targeting parameters 228 may specify one or more conditions that, if satisfied, may trigger selection of a query advertisement. The search system 100 may send one or more query advertisements to a user device 108 when targeting parameters are satisfied for the one or more query advertisements. A plurality of targeting parameters are described herein. Targeting parameters for a query advertisement may include one or more of the described targeting parameters.

In some implementations, the advertiser may specify one or more query terms that trigger selection of a query advertisement. For example, the advertiser may specify one or more partial search queries. Additionally, or alternatively, the advertiser may specify one or more completed queries that may trigger the query advertisement for selection. In a specific example (e.g., see FIG. 2), an advertiser may specify that the partial query “mcdon” should trigger a query advertisement for “McDonalds near me”, with query advertisement metadata limiting results to a specific application. In another example, the specified partial query may not include a subset of characters of the query advertisement. For example, an advertiser may specify a competing business entity for a partial query. In one example, an advertiser for a first restaurant may specify that a query advertisement be shown for the first restaurant when a partial query for a different competing restaurant is being typed. For example, a user typing “mcd” may trigger an advertisement for a BURGER KING® restaurant, such as a query advertisement of “burger king coupons” or “Burger King near me, open now.”

In some implementations, the advertiser may specify targeting parameters that are based on context. For example, context targeting parameters may include, but are not limited to, user geolocation, the state of the user (e.g., walking, driving, etc.), device context parameters (e.g., OS, device type, etc.), and other context parameters described herein. In one example, a user that is walking near a STARBUCKS® coffee shop may be shown a query advertisement for “Starbucks discount codes” or “open Starbucks app and place an order.”

In some implementations, the advertiser may specify targeting parameters that are based on user-specific data. For example, targeting parameters may include application installation status (e.g., whether an application is installed). As another example, targeting parameters may include application and/or website usage data, such as 1) a number of times the user has accessed (e.g., opened/viewed) application pages and/or websites, 2) whether the user has made a purchase, 3) whether the user has performed other actions associated with the application/website, and/or 4) the amount of time that has passed since the last time the user has opened the application. The targeting parameters may be determined based on data that is stored locally on the user device 108 and/or acquired by the remote search system 100 and/or advertisement system 102. In order to maintain user privacy and prevent an advertiser from benefiting from another entity's data, the targeting parameters associated with application/website usage may be limited to specific data that is available to the advertiser. For example, an advertiser may be restricted to only using application/website usage data associated with the advertiser's client/business. For example, a restaurant corporation may not be allowed to target query advertisements based on the installation status of a different restaurant corporation's application.

In some implementations, query advertisements may be generated by the search system 100 and/or advertisement system 102 based on potential post-query selection events. A post-query selection event may refer to any event that occurs after selection of a query advertisement. In these implementations, query advertisements may be generated based on the potential (e.g., a probability or likelihood) that one or more post-query selection events will occur. The search system 100 and/or advertisement system 102 may determine the probabilities associated with one or more post-query selection events. Additionally, in some implementations, the query advertisements may be generated based on the potential monetary value of the post-query selection events. The potential value may be based on the probability of occurrence for the post-query selection event and the value of the event to the operator of the search system 100 and/or advertisement system 102. In cases where query advertisements are generated based on post-query selection events, the query advertisement may itself not be a sponsored advertisement, but the query advertisement may be rendered as an advertisement due to the potential monetization events that occur after selection of the query advertisement. Example monetization events may include advertising revenue and/or other commissions on products/services. Query advertisement generation based on post-query selection events may occur without a user query, with a partial search query, and/or with a completed search query.

Post-query selection events may include a variety of types of events. In some implementations, post-query selection events may include the viewing of an advertisement on the SERP or other page. In some implementations, post-query selection events may include selection of an advertisement on the SERP or other page. Post-query selection events may also refer to any application event and/or web event that occurs downstream (e.g., afterwards) from the advertisement selection, such as an application installation and/or a purchase event. In some implementations, post-query selection events may refer to one or more interactions with the search results (e.g., organic search results) that result in a specified event, such 1) an opening of an application (e.g., re-engagement with an application), 2) visiting a website from the search results, and/or 3) other events, such as an application installation, purchase of an item, registration event, an advertiser-defined event, or any other downstream event.

The query advertisements may be generated based on the likelihood of a user viewing and/or selecting an advertisement in the search results. Example advertisements may include advertised links, graphical advertisements (e.g., banners), and/or video advertisements. The different advertisements may promote different user actions, such as installing an application, re-engaging with an application by opening the application, and/or other commerce actions (e.g., purchasing products/services). Advertisers may pay the search system 100 and/or advertisement system 102 for one or more of the user actions associated with the advertisements, such as advertisement viewing/selection, application installation, and/or commerce actions.

In one specific example, re-engagement advertisements may be paid for by developers to promote re-engagement with their applications. In another specific example, the search system owner may have business deals with an application that provide commissions for search traffic that leads to sales generated within the application. In this example, a user searching for “iph” may result in the automatic generation of a query advertisement for “iPhone store on Amazon”, which may direct the user into the Amazon shopping application to purchase an iPhone smartphone by Apple, inc. Similarly, a query for “cof” (e.g., short for “coffee”) may yield a query advertisement for “Order Now on Starbucks App”, which may direct the user into the STARBUCKS® application for a potential sale. In another specific example, if users that search for “the office” often end up installing the NETFLIX® application, and the search system 100 is paid for driving installations of the NETFLIX® application, the search system 100 may generate query advertisements for “the office”. Note that in some cases of generated queries, the advertisers and/or owners of the applications may not explicitly define the query advertisements.

In some implementations, the query advertisements may be generated based on advertisements that may be shown after selection of the query advertisement. In one example, during entry of a search query (or based on context), the search application 104 may generate a query advertisement based on other potential advertisements that may be shown after selection of the query advertisement. In some implementations, prior cached searches and advertisements for prior queries/context may be used to determine whether an advertisement may potentially be shown. In these implementations, the query advertisement may itself not be a sponsored advertisement, but the query advertisement may be rendered as an advertisement due to the potential search advertisements shown in response to selection of the query advertisement. In some implementations, instead of caching prior searches and queries, the search system 100 and/or the advertisement system 102 may determine whether/which search advertisements will be shown in the search results, and then label suggested search queries as query advertisements if selection of the query advertisements will lead to display of the search advertisements.

In some implementations, a query advertisement may be generated based on the potential for one or more interactions with the search results (e.g., organic search results) or any downstream event resulting from interaction with the search results. Query advertisements generated based on potential interactions with search results and/or downstream events may be generated based on the potential (e.g., probability) for monetization that may result from a search based on the query advertisement. Note that the search results may be organic results (e.g., not advertised), and the monetization may arise from interaction with the organic results.

The search system 100 and/or advertisement system 102 may learn search queries that are likely to result in an outcome where there is an action downstream from a query advertisement. For example, the learning may be based on past user queries and subsequent advertisements and/or user actions associated with the corresponding search results. In one example, the search system 100 and/or advertisement system 102 may determine which historical search queries map to user selection of specific applications, application states, websites, and other events (e.g., purchases and installations). The search system 100 and/or advertisement system 102 may select query advertisements based on the past queries and associated downstream events. In a specific example, the search system 100 and/or advertisement system 102 may determine that users typing specific queries for smartphones (e.g., “iphone”) may end up selecting search results for a shopping application (e.g., the Amazon shopping application). Furthermore, selection of the search results may also typically result in a purchase in the shopping application. In this case, the search system 100 and/or advertisement system 102 may determine that showing the specific smartphone query may have a high probability of resulting in a shopping application event, such as an application open and/or a purchase.

In some implementations, the search system 100 and/or advertisement system 102 may select one or more organic autosuggest search queries to be used as query advertisements based on the probability that the query advertisements lead to monetized downstream events. In some cases, the search system 100 and/or advertisement system 102 may generate a query advertisement by ranking an organic autosuggest search query higher in the suggested search queries if the organic autosuggest search query may result in monetized downstream events. In a specific case, an organic suggested search query that may originally appear low in the drop down search box, or not at all, may be ranked higher in the drop down search box if selection of the organic suggested search query may lead to monetized downstream events.

In some implementations, the search system 100 and/or advertisement system 102 may generate query advertisements by modifying historical user queries, modifying suggested search queries, and/or by generating new search queries. In one example, a query may be modified by adding application/domain specific modifiers. For example, the advertisement system 102 may add an application/domain modifier to a suggested search query (e.g., organic suggested query) that limits the search system 100 to a search for content (e.g., links) associated with a specific web domain and/or application. As another example, the advertisement system 102 may add an application modifier to the suggested search query (e.g., organic suggested query) that causes the application to launch and perform an application-specific search using the query. Example modifications for the search query and/or metadata are described herein. In a specific example, the search system 100 and/or advertisement system 102 may add a shopping application constraint to a suggested search query (e.g., an organic suggested query) in order to cause a search to occur in the shopping application. In some cases, the query may be generated by the advertisement system 102 and/or the search system 100 based on monetizable options, such as which advertisers/applications have current monetization deals with the system(s) 100, 102.

In some implementations, query advertisements may be generated based on application/website content knowledge, such as the contents of the application/website and the relative popularity of application/website content. For example, query advertisements may be generated based on text included in SERPs, application pages, and/or websites. The text may be descriptive of content in the SERPs, applications, and/or websites. Note that query advertisements generated based on content may include query text and/or other metadata that may not have been previously entered by users.

In some implementations, the advertisement system 102 may look at the organic autosuggested queries in real time and identify applications that are most relevant to the autosuggested queries. Organic autosuggested queries may refer to autosuggest queries that are generated by an autosuggest engine (e.g., at the search system 100), without taking into account advertising. If any of the identified applications have pending install advertisements or re-engagement advertisements, then the advertisement system 102 may set those queries as query advertisements.

In some implementations, query advertisements may be generated dynamically based on advertisement inventory. For example, query advertisements may be generated in a manner that may trigger search result advertisements after selection of the query advertisement. For example, if a business sponsors advertisements associated with specific keywords, the search application may provide suggested search queries including those specific keywords, which may potentially lead to display of the sponsored search advertisements upon query selection.

In some implementations, the advertiser may specify a bid 230 for the query advertisement that indicates an amount the advertiser will pay for actions associated with the query advertisement. For example, the bid may be an amount to be paid for showing the advertisement, a user selecting the advertisement, and/or performing an action after selecting the advertisement (e.g., installing an application or making a purchase). In some implementations, the search application may rank the query advertisements based on the potential to monetize the advertisements. In a specific example, the search application may rank query advertisements higher (e.g., nearer to the top of a list) that are potentially more valuable (e.g., based on a bid price and/or probability of selection).

In some implementations, an advertiser may bid for a query (e.g., partial/complete) as both a query advertisement and another advertisement, such as a search result advertisement to be shown in the search results. In this implementation, the partial/complete query may initially cause display of a query advertisement. Selection of the query advertisement may then lead to search results including the other advertisement (e.g., the search advertisement in the search results). In some cases, the query advertisement may not be selected by the user. Instead, the user may execute the search with the partial/complete user search query. In this case, the executed search may display the other advertisement (e.g., the search advertisement).

In block 302, the user interacts with a search interface (e.g., a search application 104) on the user device 108. The user device 108 sends an advertisement request 214 to the search system 100 and/or the advertisement system 102. The search application 104 may generate advertisement requests in response to a variety of triggers described herein.

In some implementations, the search application 104 may generate an advertisement request before the user accesses the search application. For example, the search application may be configured to send advertisement requests at predetermined times (e.g., at fixed times or periodically) and/or based on user context, such as user location. In this example, the search application may automatically receive query advertisements that are relevant to local businesses, such as a query that searches for a specific local business that is near the user. In some cases, the search application may be configured to send advertisement requests based on changes in the user's location, such as if the user's location changes by more than a threshold amount (e.g., the user leaves their home for work or has walked a block).

In some implementations, the search application 104 may send advertisement requests 214 in response to a condition associated with sensors on the user device. For example, an advertisement request may be sent in response to the user device detecting a transition from dark to light (e.g., being pulled from a user's pocket). In another example, the search application may send advertisement requests in response to detection that the user is moving or stopping (e.g., from 50 miles per hour to 0), such as detection that the user has transitioned from driving to stationary.

In some implementations, the search application 104 may generate an advertisement request 214 in response to the user accessing the search application 104, such as opening the search application 104 and/or accessing the search page of an application. In some implementations, the search application may generate an advertisement request in response to a user gesture, such as a user swiping gesture that exposes a search box. In some implementations, the search application may generate an advertisement request in response to the user device transitioning to a state in which the search box is present (e.g., when the screen turns from off to on). With respect to FIG. 4B, note that the search application has provided suggested queries (e.g., “News” and “Recent Earthquakes”) for the user prior to entry of a search query into the empty search box 408. The query for “McDonalds near me” is a query advertisement that may have been generated based on the user's geolocation or other targeting parameters described herein.

In some implementations, the search application 104 may generate advertisement requests 214 while the user is typing the search query. For example, the search application may generate advertisement requests in response to one or more typed characters. In some implementations, the search application may generate advertisement requests after the user has finished the search query, but before the user has executed the search query by selecting a search GUI element 206. In some implementations, the search application may generate advertisement requests after the user has executed the search (e.g., in response to execution of the search).

The advertisement request 214 may include a variety of data. For example, the advertisement request can include partial and/or complete user search queries. The advertisement request may also include context data (e.g., geolocation and time of day). In some implementations, the advertisement requests may include an identifier that may be used by the search system 100 and/or the advertisement system 102 to identify prior user activity in websites/applications.

In block 304, the advertisement system 102 selects one or more query advertisements based on the received advertisement request 214. For example, the advertisement system may select query advertisements that have satisfied targeting parameters (e.g., query terms, user context, etc.). In some implementations, multiple query advertisements may be selected. In these implementations, the advertisement system may select a subset (e.g., one or more) of the query advertisements. For example, the advertisement system may select the subset based on bids associated with the subset. In a specific example, the advertisement system may select the subset of query advertisements that are associated with the highest bid amounts and/or the highest estimated monetary value (e.g., likelihood of selection multiplied by bid price).

In block 306, the advertisement system 102 and/or the search system 100 sends the selected query advertisement response 216 to the user device 108. The advertisement response may include data used to render the query advertisement along with data that controls how the search application responds to selection of the query advertisement.

In block 308, the search application 104 displays the query advertisement in the search interface. A query advertisement can be placed in a variety of locations. In some cases, a query advertisement can be placed near the search box 200 (e.g., next to the search box), such as under the search box 200 or above the search box. In some cases, a query advertisement can be in a drop-down menu 202 as the user is typing the search query. For example, with respect to FIG. 2, a query advertisement for “McDonalds near me” is provided in a drop-down menu 202 with other suggested queries 208-1, 208-2 in response to a partial query of “mcdon.” Query advertisements may also be located in a designated section of the search interface, such as a section that is separated from the search box 200 or integrated in with the additional search queries. A query advertisement may be located alone, or with other search queries and/or search results. With respect to FIG. 4A, note that the query advertisement 402 for Avengers tickets in the FilmTicks movie tickets application is located in a suggested query section of the search interface with additional suggested queries. Also note the example of FIG. 4B in which the query advertisement 404 is located with other suggested search queries where no search results are provided.

In block 310, the user selects the query advertisement. For example, the user may select the query advertisement by touching/clicking the query advertisement. In block 312, the user device 108 may send a search request 210 to the search system 100 in response to selection of the query advertisement. The search request 210 may include a search query associated with the query advertisement, along with additional data, such as user context data or other metadata. In some implementations, the search application 104 may perform a local search and selection of an advertisement (e.g., see FIGS. 8A-8B) in response to selection of the query advertisement.

In block 314, the search system 100 generates search results based on the received search request 210. In block 316, the search system 100 sends the search results to the user device in a search response 212. The user device 108 (e.g., the search application 104) may render the received search results as a search results page.

Selection of a query advertisement (e.g., in block 310) may cause a variety of different actions. In one example, a general search may be executed, such as a search across a search corpus (e.g., a search index) for a plurality of applications and websites. In another example, a query advertisement may cause a search to be executed for a specific application and/or website. For example, the query advertisement may specify that the search be limited to searching a search corpus for a single application/website or portion of an application/website. In another case, selection of a query advertisement may cause the user device to launch a search component of an application/website. For example, selection of a query advertisement may cause an application to launch on the user device and insert a search query for the query advertisement into the search component for the application.

The advertisement system 102 may monitor performance metrics associated with the query advertisements. For example, the advertisement system 102 may maintain performance data that indicates: 1) whether the query advertisement was shown to the user, 2) the rank of the advertisement in the query box, 3) where the query advertisement was placed (e.g., in a search box or other GUI), and 4) whether the query advertisement was selected by the user. In some implementations, the advertisement system 102 may determine whether selection of the advertisement was followed by a downstream event (e.g., in an application). Example downstream events may include, but are not limited to: 1) whether a sponsored link was shown, 2) whether a purchase was made, and 3) whether the user engaged with an entity in an application/website that is relevant to the query advertisement (e.g., whether a query for “shoes” led to a purchase of shoes in an application).

FIGS. 5-7 illustrate example methods for generating query advertisements. In the method of FIG. 5, query advertisements may be used as advertisements in the context of search suggestions that may be automatically suggested (e.g., in response to entries in the search box 200). For example, a user may type “gaa” (the first few characters of the Indian music application Gaana), which may cause a query advertisement for “Spotify—Stream Bollywood Hits,” where “Spotify” refers to the SPOTIFY® music streaming application developed by Spotify Technology S.A.

In block 500, the user enters a partial query. In block 502, the search application 104 generates an advertisement request 214 that includes the partial query and optional additional information, such as context data. In block 504, the advertisement system 102 selects one or more query advertisements based on a variety of data, such as the partial query, the context data, and bids associated with the query advertisements. In block 506, the advertisement system 102 sends the one or more selected query advertisements to the user device 108. In block 508, the search application 104 displays the received query advertisement(s) as suggested queries (e.g., as autosuggest queries) for user selection.

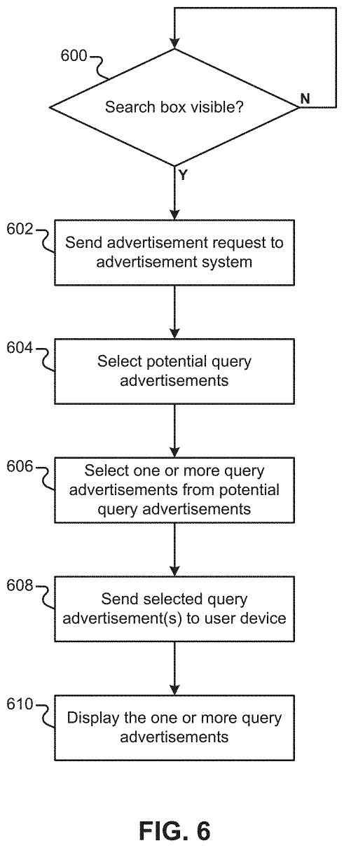

FIG. 6 illustrates an example method that describes the generation of query advertisements in response to triggers other than an entered search query. Specifically, FIG. 6 illustrates a method in which the search application 104 triggers an advertisement request in response to the search box being displayed to the user. In block 600, the search application 104 determines whether the search box 200 is visible. When the search box 200 is visible, the search application 104 sends an advertisement request 214 to the advertisement system 102 in block 602. The advertisement request 214 may include context data, such as the time of day, the user's geolocation, and user device information (e.g., device model and operating system).

In block 604, the advertisement system 102 selects a set of potential query advertisements. For example, the advertisement system 102 may select potential query advertisements based on the user's context data. In block 606, the advertisement system 102 selects one or more of the potential query advertisements based on additional data, such as bids associated with the potential query advertisements. In block 608, the advertisement system 102 sends the selected one or more query advertisements to the user device 108. In block 610, the search application 104 displays the one or more query advertisements.

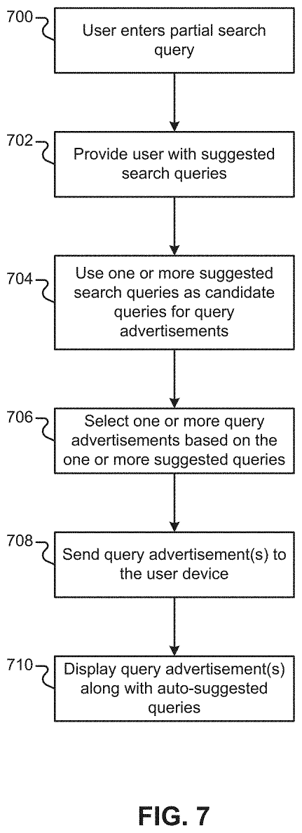

FIG. 7 illustrates an example method in which autosuggested search queries are used to select query advertisements. For example, the search system 100, or another remote/local autosuggest system (not illustrated), may organically generate the suggested search queries without regard to advertisements. The advertisement system 102 may then use the suggested search queries as targeting parameters for identifying and selecting query advertisements. In the method of FIG. 7, advertisers may include autosuggest query terms as targeting parameters for query advertisements.

In block 700, the user enters a partial search query. In block 702, the user is provided with suggested search queries by the search system 100, search application 104, or other autosuggest system (not illustrated) based on the entered partial search query. Although autosuggested search queries may be generated based on a user partial search query, autosuggested search queries may be based on other information, such as context data.

Autosuggest queries may be generated in a variety of ways. In some implementations, the search application 104 (or other system) may determine a user intent (e.g., an intended search category or action), and then generate an autosuggest query, such as a category for search or specific action query term. In some implementations, the search application 104 (or other system) may identify concepts from the query/context, and then generate an autosuggest query based on the identified concepts. In some implementations, the search application 104 (or other system) may identify one or more applications based on the query/context and generate an autosuggest query based on the identified applications. In some implementations, the search application 104 may identify the one or more applications based on the determined user intent, category, and/or action. In some cases, the search application may compare the user's partial query to completed queries of other users to generate autosuggest queries.

In block 704, the advertisement system 102 uses one or more of the suggested search queries as candidate search queries for one or more query advertisements. For example, the advertisement system 102 may use the highest ranking suggested query for identifying one or more query advertisements. In block 706, the advertisement system 102 selects one or more query advertisements based on a variety of data, such as the partial query, one or more suggested queries, and the bids associated with the query advertisements. In block 708, the advertisement system 102 sends the one or more query advertisements to the user device. In block 710, the search application 104 displays the received query advertisement(s) as suggested queries (e.g., as autosuggest queries) for user selection (e.g., along with the other autosuggested queries).

In one example, with respect to the method of FIG. 7, the owner/operator of the SPOTIFY® music service may buy an autosuggest query advertisement for the query “gaana.” When the user types “gna,” the autosuggest server may return “Gaana” as the first autosuggestion, even though the original query is a misspelling. The first autosuggestion “gaana” may then be sent to the advertisement system, which may then select the SPOTIFY® advertisement. The SPOTIFY® advertisement may then be added into the autosuggest results.

FIGS. 8A-8B illustrate an example local implementation of the query advertisement functionality on a user device 800. In FIG. 8A, a search application 801 may include a local advertisement module 802 and local advertisement data 804 that implement the query advertisement functionality described herein. For example, the local advertisement data 804 may include query ad records and other advertisement records that are stored on the user device 800. The advertisement module 802 may include the functionality attributed to the advertisement system 102 herein. For example, the advertisement module 802 may select query advertisements based on partial/complete search queries, context data, application installation data, and/or application/web usage data.

The user device 800 may also include a local search module 806 and local search data 808 that may implement the search functionality described herein. For example, the local search data 808 may include a search index for providing local search functionality. The local search data 808 may also include local query suggestion data that may provide query suggestions for a query input. The local search module 806 may provide the search functionality attributed to the search system 100 herein. For example, the search module 806 may receive a user search query and/or a selected query advertisement, perform a local search (e.g., using the search index), and return search results.

In some implementations, the search application 801 may communicate with a remote search system 810 and/or remote advertisement system 812. The remote search system 810 and/or remote advertisement system 812 may provide similar functionality as described with respect to the search system 100 and advertisement system 102 described herein. In some implementations, the search application 801 may retrieve search data (e.g., updated search data) and advertisement data (e.g., updated advertisement data) from the remote search system 810 and the remote advertisement system 812. Although the search application 801 may perform search and/or query advertisement functionality locally, the search application 801 may use the remote search system 810 and/or the remote advertisement system 812 along with, or in place of, the local search and query advertisement functionality.

FIG. 8B illustrates an example method that describes operation of the search application 801 that implements local search and local query advertising. In the method of FIG. 8B, query advertisements may be used as advertisements in the context of search suggestions that may be automatically suggested (e.g., in response to entries in the search box 200). Although entry of a partial query may trigger a local query advertisement and/or search, the search application 801 may perform local query advertisements and/or search in response to other triggers, such as triggers based on context data.

In block 820, the user enters a partial query. In block 822, the search application 801 selects one or more local query advertisements based on the partial query and optional additional information, such as context data. In block 824, the search application 801 displays the received local query advertisement(s) as suggested queries (e.g., as autosuggest queries) for user selection. In block 826, the search application 801 detects user selection of the local query advertisement. In block 828, the search application 801 (e.g., search module 806) performs a local search based on the selected query advertisement.

The systems, modules, and data stores described herein may be embodied by electronic hardware, software, firmware, or any combination thereof. Depiction of different features as separate systems, modules, and data stores does not necessarily imply whether the systems, modules, and data stores are embodied by common or separate electronic hardware or software components. In some implementations, the features depicted herein may be realized by common electronic hardware and software components. In some implementations, the features depicted herein may be realized by separate electronic hardware and software components.

The systems, modules, and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components.

The one or more processing units may include one or more central processing units (CPUs), graphics processing units (GPUs), digital signal processing units (DSPs), or other processing units. The one or more processing units may be configured to communicate with memory components and I/O components. For example, the one or more processing units may be configured to communicate with memory components and I/O components via the interconnect components.

A memory component (e.g., main memory and/or a storage device) may include any volatile or non-volatile media. For example, memory may include, but is not limited to, electrical media, magnetic media, and/or optical media, such as a random access memory (RAM), read-only memory (ROM), non-volatile RAM (NVRAM), electrically-erasable programmable ROM (EEPROM), Flash memory, hard disk drives (HDD), magnetic tape drives, optical storage technology (e.g., compact disc, digital versatile disc, and/or Blu-ray Disc), or any other memory components.

Memory components may include (e.g., store) data described herein. For example, the memory components may include the data included in the systems and data stores. Memory components may also include instructions that may be executed by one or more processing units. For example, memory may include computer-readable instructions that, when executed by one or more processing units, cause the one or more processing units to perform the various functions attributed to the systems and modules described herein.

The I/O components may refer to electronic hardware and software that provides communication with a variety of different devices. For example, the I/O components may provide communication between other devices and the one or more processing units and memory components. In some examples, the I/O components may be configured to communicate with a computer network. For example, the I/O components may be configured to exchange data over a computer network using a variety of different physical connections, wireless connections, and protocols. The I/O components may include, but are not limited to, network interface components (e.g., a network interface controller), repeaters, network bridges, network switches, routers, and firewalls. In some examples, the I/O components may include hardware and software that is configured to communicate with various human interface devices, including, but not limited to, display screens, keyboards, pointer devices (e.g., a mouse), touchscreens, speakers, and microphones. In some examples, the I/O components may include hardware and software that is configured to communicate with additional devices, such as external memory (e.g., external HDDs).

In some implementations, the search system 100 and advertisement system 102 may include one or more computing devices that are configured to implement the techniques described herein. Put another way, the features attributed to the systems 100, 102, modules, and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the systems 100, 102 may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the systems 100,102 may be configured to communicate with the network 110. The one or more computing devices of the systems 100, 102 may also be configured to communicate with one another (e.g., via a computer network). In some examples, the one or more computing devices of the systems 100, 102 may include one or more server computing devices configured to communicate with user devices. The one or more computing devices may reside within a single machine at a single geographic location in some examples. In other examples, the one or more computing devices may reside within multiple machines at a single geographic location. In still other examples, the one or more computing devices of the systems 100, 102 may be distributed across a number of geographic locations.

What is claimed is:

1. A method comprising:
receiving, at a computing device, a first request from a user device, wherein the first request includes a partial search query sent from the user device while a user is typing a search query;
generating, at the computing device, one or more suggested search queries based on the partial search query;
selecting, at the computing device, a query advertisement record based on the partial search query, wherein the query advertisement record includes an advertised search query and a bid price associated with the advertised search query;
sending, from the computing device, a first response to the user device, wherein the first response includes the advertised search query and the one or more suggested search queries;
receiving, at the computing device, a second request that includes the advertised search query;
generating, at the computing device, search results based on the advertised search query included in the second request; and
sending, from the computing device, the search results to the user device.

2. The method of claim 1, wherein the first request includes geolocation data that indicates a current geolocation of the user device, and wherein the method further comprises selecting the query advertisement record based on the geolocation data.

3. The method of claim 1, further comprising:
determining, at the computing device, whether a specific application is installed on the user device; and
selecting the query advertisement record based on whether the specific application is installed on the user device.

4. The method of claim 1, further comprising selecting the query advertisement record based on application usage data for the user device.

5. The method of claim 1, further comprising:
estimating a monetary value for the advertised search query; and
selecting the query advertisement record from a plurality of additional query advertisement records based on the estimated monetary value of the advertised search query.

6. The method of claim 1, further comprising:
estimating a monetary value for a potential event that occurs after selection of the advertised search query on the user device; and
selecting the query advertisement record from a plurality of additional query advertisement records based on the estimated monetary value.

7. The method of claim 6, wherein the potential event includes displaying an advertisement in the search results on the user device.

8. The method of claim 6, wherein the potential event includes an event for an application that occurs after selection of one of the search results on the user device.

9. The method of claim 8, wherein the potential event includes at least one of installing the application on the user device and performing an action in the application.

10. The method of claim 1, wherein the advertised search query includes an application name and a search operator that limit the search results to search results associated with the application name.

11. The method of claim 1, wherein the query advertisement record includes metadata that specifies an application, wherein the first response to the user device includes the metadata, wherein the second request includes the metadata, and wherein generating the search results comprises generating the search results using the metadata as an application filter that limits search results to search results associated with the application.

12. The method of claim 1, wherein the query advertisement record includes metadata that specifies an application, wherein the first response to the user device includes the metadata, wherein the second request includes the metadata, wherein the metadata is configured to launch a search page for the application on the user device, and wherein the metadata is configured to insert the advertised search query into the search page for the application.

13. The method of claim 1, wherein the advertised search query includes an advertisement indicator for rendering on the user device, and wherein the advertisement indicator indicates to the user that the advertised search query is an advertisement.

14. The method of claim 1, wherein the search results are a final set of search results, and wherein the first response includes an initial set of search results along with the advertised search query and the one or more suggested search queries.

15. The method of claim 1, further comprising:
selecting, at the computing device, a search result advertisement based on the partial query; and
sending the search result advertisement with the search results to the user device.

16. A system comprising:
one or more storage devices configured to store a plurality of query advertisement records; and
one or more processing units that execute computer-readable instructions that cause the one or more processing units to:
receive a first request from a user device, wherein the first request includes a partial search query sent from the user device while a user is typing a search query;
generate one or more suggested search queries based on the partial search query;
select a query advertisement record based on the partial search query, wherein the selected query advertisement record includes an advertised search query and a bid price associated with the advertised search query;
send a first response to the user device, wherein the first response includes the advertised search query and the one or more suggested search queries;
receive a second request that includes the advertised search query;
generate search results based on the advertised search query included in the second request; and
send the search results to the user device.

17. The system of claim 16, wherein the first request includes geolocation data that indicates a current geolocation of the user device, and wherein the one or more processing units are configured to select the query advertisement record based on the geolocation data.

18. The system of claim 16, wherein the one or more processing units are configured to:
determine whether a specific application is installed on the user device; and
select the query advertisement record based on whether the specific application is installed on the user device.

19. The system of claim 16, wherein the one or more processing units are configured to select the query advertisement record based on application usage data for the user device.

20. The system of claim 16, wherein the one or more processing units are configured to:
estimate a monetary value for the advertised search query; and
select the query advertisement record from the plurality of query advertisement records based on the estimated monetary value of the advertised search query.

21. The system of claim 16, wherein the one or more processing units are configured to:
estimate a monetary value for a potential event that occurs after selection of the advertised search query on the user device; and
select the query advertisement record from the plurality of query advertisement records based on the estimated monetary value.

22. The system of claim 21, wherein the potential event includes displaying an advertisement in the search results on the user device.

23. The system of claim 21, wherein the potential event includes an event for an application that occurs after selection of one of the search results on the user device.

24. The system of claim 23, wherein the potential event includes at least one of installing the application on the user device and performing an action in the application.

25. The system of claim 16, wherein the advertised search query includes an application name and a search operator that limit the search results to search results associated with the application name.

26. The system of claim 16, wherein the query advertisement record includes metadata that specifies an application, wherein the first response to the user device includes the metadata, wherein the second request includes the metadata, and wherein the one or more processing units are configured to generate the search results by generating the search results using the metadata as an application filter that limits search results to search results associated with the application.

27. The system of claim 16, wherein the query advertisement record includes metadata that specifies an application, wherein the first response to the user device includes the metadata, wherein the second request includes the metadata, wherein the metadata is configured to launch a search page for the application on the user device, and wherein the metadata is configured to insert the advertised search query into the search page for the application.

28. The system of claim 16, wherein the advertised search query includes an advertisement indicator for rendering on the user device, and wherein the advertisement indicator indicates to the user that the advertised search query is an advertisement.

29. The system of claim 16, wherein the search results are a final set of search results, and wherein the first response includes an initial set of search results along with the advertised search query and the one or more suggested search queries.

30. The system of claim 16, wherein the one or more processing units are configured to:
select a search result advertisement based on the partial query; and
send the search result advertisement with the search results to the user device.
